(19) United States
(12) Patent Application Publication
(10) Pub. No.: US 2012/0208081 A1
(43) Pub. Date: Aug. 16, 2012

(54) COATING METHOD FOR PRODUCING ELECTRODES FOR ELECTRICAL ENERGY STORES

(75) Inventors: Bernd Bartkowiak, Oer-Erkenschwick (DE); Armin Modlinger, Kamenz (DE); Peter Pilgram, Ingolstadt (DE); Markus Rudek, Marl (DE); Claudia Veit, Muenchen (DE)

(73) Assignee: Evonik Degussa GmbH, Essen (DE)

(21) Appl. No.: 13/384,786

(22) PCT Filed: May 25, 2010
(86) PCT No.: PCT/EP2010/057163

§ 371 Date: May 4, 2012

(30) Foreign Application Priority Data
Jul. 25, 2009 (DE) 102009034799.2

(51) Int. Cl. H01M 4/02; H01M 4/04; B05D 5/12; H01M 4/131; H01M 4/133; H01M 4/134; H01M 4/136; B32B 27/30; B32B 27/32; B32B 27/00; B32B 3/24; B32B 15/08; B32B 5/02; H01B 1/20; B32B 9/04

(52) U.S. Cl. 429/209; 428/704; 427/58; 427/122; 427/123; 427/126.3; 427/126.1; 428/421; 428/422; 428/522; 428/523; 428/521; 428/473.5; 252/182.1; 252/500

(57) ABSTRACT

The present invention relates to a method for coating a carrier during the production of an electrode for electrical energy stores, in particular for lithium ion cells, using a specific solvent and/or dispersant, characterized in that the solvent and/or dispersant is or comprises N-ethylpyrrolidone.

The present invention relates to a process for coating a carrier in the production of an electrode for electrical energy stores, especially for lithium ion cells, using a specific solvent and/or dispersant.

In the production of electrodes, especially for lithium ion batteries, according to the prior art, coating compositions or dispersions comprising active materials, conductivity additives and binders are coated onto conductive foils in wet-chemical processes. These dispersions are produced using systems based either on water or on organic solvents. In the case of water-based systems, the binder is dispersed, with spot binding between the particles.

The behavior is different in the systems based on organic solvents, in which the binder dissolves fully in the solvent and the binder envelops the particles. For the coating operation, complete dissolution of the binder in the overall dispersion has to be ensured. A particularly suitable organic solvent for the production of electrodes has been found to be N-methylpyrrolidone (NMP).

Typically, the quality of the coating composition is checked by measuring the viscosity of the dispersion or of the solution. It should be noted that the viscosity of the coating composition can alter over the course of several hours, such that the composition is not used directly after production. A further problem with NMP is also that it is classified as toxic (teratogenic). For reasons of health and safety at work and for environmental reasons, there is therefore a need to replace this NMP. A further need is to provide solvent-based systems for production of these dispersions which acquire less solvent or dispersant than is the case with NMP.

It was thus an object of the present invention, in the production of electrodes for electrical energy stores, especially for lithium ion cells, wherein active materials, binders and additives are applied to a carrier in a coating process, to find a means of achieving the application of the active materials and additives with a smaller amount of dispersant or solvent, i.e. enabling higher solids contents in what is called the electrode slurry. At the same time, the dispersant or solvent shall satisfy safety and environmental regulations, and additionally have good storage stability, i.e. improved with respect to NMP.

This object is surprisingly achieved by the use of N-ethylpyrrolidone (NEP) instead of N-methylpyrrolidone (NMP) as a solvent and/or dispersant in the coating composition which is used in the wet-chemical process step in electrode production.

The invention thus provides a process for coating a carrier in the course of production of an electrode for electrical energy stores, comprising the steps of: a) providing a composition comprising at least one solvent and/or dispersant and additionally at least one polymeric binder, b) coating the carrier with the composition, characterized in that the solvent and/or dispersant is or comprises N-ethylpyrrolidone.

The coating process according to the invention thus envisages, in its broadest possible application, coating of a carrier with a composition which comprises at least N-ethylpyrrolidone and a polymeric binder. Typically, the coating composition comprises, in addition to the N-ethylpyrrolidone as a solvent and/or dispersant and the polymeric binder, also at least one so-called active material and a conductivity additive. The carrier coated with the coating composition is subsequently used further to produce an electrode, and the electrode in turn can be used for the production of an electrical energy store. The production of the electrode typically also comprises the step of drying the coated carrier. More particularly, the solvent and/or dispersant is removed to form a solid, conductive layer which is “active” after completion of the electrical energy store. The carrier itself is typically conductive, as is the case, for example, in the standard lithium ion cells. More detailed remarks will be made hereinafter with regard to the individual components used and different aspects of the invention.

The polymeric binder has the task of ensuring good adhesion, both within the layer and to the carrier. Particular preference is given to using polyvinylidene fluoride homopolymers (PVDF). The use of PVDF is desirable due to its electrochemical stability and because the swelling of PVDF in the electrolyte of the electrical energy store which is finished at a later stage is low. Suitable binders for the inventive application are, however, also different PVDF copolymers, Teflon, polyamides, polynitriles and others. Preferred polymeric binders may be selected from the group comprising polyvinylidene fluoride homopolymers (PVDF); polyvinylidene fluoride copolymers (PVDF copolymers), e.g. PVDF-hexafluoropropylene (PVDF-HFP), PVDF-tetrafluoroethylene (PVDF-TFE) and PVDF-chlorotetrafluoroethylene (PVDF-CTFE); mixtures of PVDF and PVDF copolymer(s); polytetrafluoroethylene (PTFE); polyvinyl chloride (PVC); polyvinyl fluoride (PVF); polychlorotrifluoroethylene (PCTFE); polychlorotrifluoroethylene-ethylene (ECTFE); polytetrafluoroethylene-ethylene (ETFE); polytetrafluoroethylene-hexafluoropropene (FEP); polymethyl methacrylate (PMMA); polyethylene oxide (PEO); polypropylene oxide (PPO); polypropylene (PP); polyethylene (PE); polyimide (PI); and styrene-butadiene rubber (SBR). It is also optionally possible to use mixtures of binders, for example mixtures of PVDF homopolymer and copolymer in any desired ratios, or the binders may be crosslinkable.

As mentioned above, a coating composition of the type described here comprises, in addition to the solvent and/or dispersant and the polymeric binder, also at least one so-called active material. “Active material” is understood here by the person skilled in the art in general terms to mean a material which enables the reversible incorporation and release of electrically charged particles. In the finished and operable electrical energy store, it is then possible for a charge or discharge current to flow, according to the structure of the store, during the incorporation or release operation of the electrically charged particles. In the case of a lithium ion cell, the electrically charged particles are lithium ions. The incorporation and release operations each take place at the cathode and at the anode in the case of charging or discharging. For the production of anode and cathode, different active materials are used in each case. In the process according to the invention, the coating composition therefore typically additionally comprises an active material which enables the reversible incorporation and release of electrically charged particles and which is preferably selected from the group comprising graphite; amorphous carbons, for example hard carbon, soft carbon; lithium storage metals and alloys (e.g. nanocrystalline or amorphous silicon and silicon-carbon composites; tin, aluminum, antimony); Li₄Ti₅O₁₂ or mixtures of these materials; lithium-metal oxides of the LiMₓO₂ type (e.g. LiCoO₂; LiNiO₂; LiNi₁₋ₓCoₓO₂; LiNi_{0.85}Co_{0.1}Al_{0.05}O₂; Li₁₊ₓ(Ni_{y}Co_{1-2y}Mn_{y})₁₋ₓO₂, 0≦x≦0.17, 0≦y≦0.5); LiMn₂O₄ spinel doped or undoped; and lithium-metal phosphates LiMPO₄ (e.g. LiFePO₄, LiMnPO₄, LiCoPO₄, LiVPO₄) doped or undoped; and conversion materials such as iron(III) fluoride (FeF₃) or mixtures of these materials. The active material is dispersed within the composition. “Soft carbon” is understood to mean non-graphitic carbons which are converted to graphite at high temperatures of up to 3200° C. “Hard carbon” is understood to mean non-graphitic carbons which are not converted to graphite at the temperatures attained in the prior art, as can be inferred, for example, from the Handbook of Battery Materials, J. O. Besenhard, Wiley VCH, pages 233 ff, 388 ff, 402 ff. Examples of useful dopants for the lithium-metal phosphates include magnesium and niobium.

Typically, a coating composition of the type described here additionally comprises at least one conductivity additive.

The latter has the task of improving the electrical conductivity of the coating and thus the electrochemical reaction, i.e. the incorporation and release of the electrically charged particles. Particular preference is given to using carbon blacks as conductive materials. Carbon blacks are carbonaceous fine solids with usually spherical primary particles of size between 10 and 300 nm, determined by means of TEM analysis to ASTM D 3849, which agglomerate to catenated aggregates and in some cases to aggregated lumps. However, suitable conductive materials for the inventive use are also fine graphites with d50 between 1 μm and 8 μm, preferably with d50 between 2 μm and 6 μm, determined by means of laser light scattering. It is optionally also possible to use mixtures of conductive materials, for example mixtures of carbon blacks and graphites in any desired ratios. In addition, the conductivity additives used may be carbon fibers.

The carrier itself is not critical for the coating process described here and the inventive use of NEP as a solvent and/or dispersant. However, it is typically electrically conductive. Especially in the standard lithium ion cells, which are considered here to be preferred, the carrier is typically a conductive foil composed of aluminum (positive electrode) or copper (negative electrode). The negative electrode may also be composed of aluminum. Other conductive metals which have appropriate redox potentials are also suitable in principle, but are not generally used for reasons of cost. According to the invention, the carrier thus consists of a conductive material web or comprises such a material, for example within a compound material. The carrier preferably consists either of aluminum or of copper or of foils of these metals. Laminates comprising such foils as carriers are also conceivable. The carriers may also be porous carriers, wovens, nonwovens or expanded metal composed of the appropriate metals, or polymeric foils, perforated foils, porous carriers, wovens or nonwovens coated with these metals.

The in the coating composition used in accordance with the invention typically comprises an N-ethylpyrrolidone content of 30 to 80% by weight, preferably 40 to 70% by weight, and, preferably, a polymeric binder content of 0.5 to 8% by weight, preferably 1.0 to 5.0% by weight, and/or an active material content of 20 to 70% by weight, preferably 30 to 60% by weight, and/or a conductivity additive content of 0 to 5% by weight, preferably 0.2 to 3% by weight, based in each case on the composition comprises.

The composition provided should have a viscosity in the range from 1000 to 7000 mPas, preferably 2000 to 5000 mPas, at a shear rate of 112 s⁻¹, measured at 20° C. The viscosity values are determined in the context of the present invention with the aid of a rheometer (RS 600 model) from Thermo Haake GmbH, Karlsruhe with a plate/plate measuring apparatus with a diameter of 35 mm. The viscosities are detected at shear rates of 1 to 500 s⁻¹. The measurements are recorded with the RheoWin software.

In the coating process according to the invention, the electrodes to be produced may be anodes or cathodes. In the production of such electrodes, the compositions used typically comprise, in addition to a solvent and/or dispersant, NEP here, and a binder, also what is called an active material as described above. Such compositions are also referred to as “electrode slurry”, “anode slurry” or “cathode slurry”, in the latter cases according to which electrode type is produced thereby.

In one embodiment of the invention, the electrode to be produced is an anode. In this case, the composition, i.e. the “anode slurry”, comprises an active material which is preferably selected from the group comprising graphite; amorphous carbon, e.g. hard carbon, soft carbon; lithium storage metals and alloys (e.g. nanocrystalline and amorphous silicon and silicon-carbon composites; tin, aluminum, antimony); and Li₄Ti₅O₁₂ or mixtures of these materials.

In one embodiment of the invention, the electrode to be produced is a cathode. In this case, the composition, i.e. the “cathode slurry”, comprises an active material which is preferably selected from the group comprising lithium-metal oxides of the LiMₓO₂ type (e.g. LiCoO₂; LiNiO₂; LiNi₁₋ₓCoₓO₂; LiNi_{0.85}Co_{0.1}Al_{0.05}O₂; Li₁₊ₓ(Ni_{y}Co_{1-2y}Mn_{y})₁₋ₓO₂), 0≦x≦0, 1.7, 0≦x≦0.5; LiMn₂O₄ spinel doped or undoped; and lithium-metal phosphates LiMPO₄ (e.g. LiFePO₄, LiMnPO₄, LiCoPO₄, LiVPO₄) doped or undoped; and conversion materials such as iron (III) fluoride (FeF₃) or mixtures of these materials.

The present invention also provides a coated carrier produced by the above-described process, provided that such a carrier is suitable for the production of an electrode for electrical energy stores. Correspondingly produced electrodes are likewise encompassed by the present invention.

The present invention further provides a composition comprising, as a solvent and/or dispersant, at least N-ethylpyrrolidone, and additionally at least one polymeric binder, an active material which enables the incorporation and release of electrically charged particles, and optionally at least one conductivity additive. A preferred composition of this type comprises an N-ethylpyrrolidone content of 30 to 80% by weight, preferably 40 to 70% by weight, a polymeric binder content of 0.5 to 8% by weight, preferably 1.0 to 5.0% by weight, an active material content of 20 to 70% by weight, preferably 30 to 60% by weight, and optionally a conductivity additive content of 0 to 5% by weight, preferably 0.2 to 3% by weight, based in each case on the composition.

The use of N-ethylpyrrolidone in electrode production for electrical energy stores and the use of N-ethylpyrrolidone for production of a composition which is used for the coating of a carrier in the production of an electrode for electrical energy stores are likewise covered by the present invention.

N-Ethylpyrrolidone is very similar to N-methylpyrrolidone in many of its chemical and physical properties. However, it has a higher boiling point and flashpoint (NMP: b.p. 202° C., m.p. 91° C.; NEP: b.p. 208-210° C., m.p. 93° C.), which has a certain advantage from the point of view of occupational and storage safety.

More particularly, an essential feature of the invention is additionally that the use of N-ethylpyrrolidone as a solvent and/or dispersant enables application of active materials and optionally additives to a carrier with a smaller amount of dispersant, i.e. achievement of higher solids contents in the composition than is possible with N-methylpyrrolidone as the dispersant.

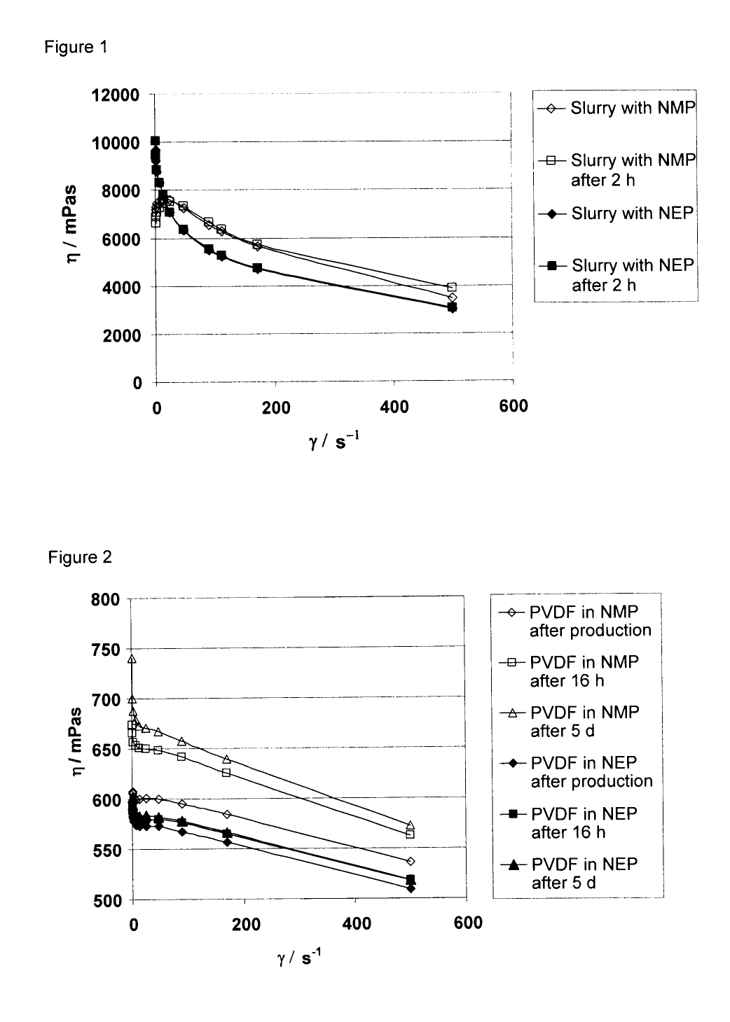

FIG. 1 describes, in a graphic representation, the viscosity characteristics n of electrode slurries with a solids content of 50% at 20° C. as a function of shear rate y. The solids content is composed of 91.5% by weight of graphite (d50=16.8 μm, BET surface area 2.5 m²/g), 8% PVDF (Solvay Solef 1013) and 0.5% carbon black (Timcal, Super P).

FIG. 2 describes, in a graphic representation, the viscosity characteristics η of 9.1% by weight PVDF homopolymer solutions (PVDF homopolymer: melt flow index, MFI 1.5−3.5 g/10 min) in NEP or NMP at 20° C. as a function of shear rate γ.

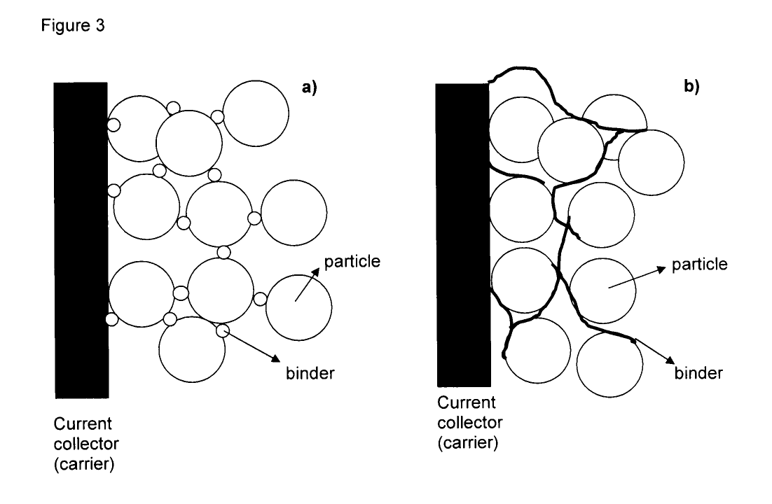

FIG. 3 shows different binder systems: a) water-based system, b) solvent-based system.

In the production of an inventive electrode slurry consisting of NMP or NEP, PVDF, graphite and a conductive carbon black, it was found that an NEP-based dispersion exhibits more significant lowering of viscosity with increasing shear rate than an NMP-based dispersion (FIG. 1). The crucial shear rates for typical coating processes are approx. 112 s⁻¹. Since NEP-based electrode slurries are present with lower viscosity at these shear rates, higher solids contents can be enabled in this case, thus achieving a reduction in the amount of dispersant. To produce such electrode slurries, the PVDF binder is frequently predissolved in the solvent in question. In the case of use of NEP as the solvent, much better storage stability is found compared to NMP as the solvent. A measure employed for the storage stability is the degree of increase in the viscosity in the solution in question with increasing storage time. The smaller the increase in viscosity with time, the greater the storage stability (FIG. 2).

### EXAMPLES

A 150 ml beaker was initially charged with the NMP or NEP, and the PVDF was added therein in portions within 15 min while stirring with a toothed disc (R1303 dissolver stirrer from IKA), diameter 42 mm, speed 750 rpm. At a PVDF content of 9.1% by weight (12.5 g in 125.0 g of solvent) the addition was stopped and stirring was continued for 1.5 h (750 rpm). Subsequently, the viscosity was determined as a function of time.

TABLE
Comparison of the solubility of PVDF in NEP and NMP

| | Viscosity | | |
|---|---|---|---|
| | in mPas at shear rates of | | |
| Rheometer: HAAKE RheoStress ® RS600 | 20 1/s | 73 1/s | 112 1/s |
| PVDF in NMP after preparation, | 600.4 | 597.1 | 592.3 |
| measurement 1 | | | |
| PVDF in NMP after preparation, | 601.5 | 600.5 | 596.1 |
| measurement 2 | | | |
| PVDF in NMP after 16 h, measurement 1 | 650.0 | 644.7 | 637.6 |
| PVDF in NMP after 16 h, measurement 2 | 651.2 | 647.4 | 641.1 |
| PVDF in NMP after 5 days, measurement 2 | 671.2 | 661.8 | 652.8 |
| PVDF in NMP after 27 days | 695.9 | 689.8 | 680.6 |
| PVDF in NEP after preparation, | 573.5 | 570.1 | 564.7 |
| measurement 1 | | | |
| PVDF in NEP after preparation, | 574.6 | 568.3 | 563.1 |
| measurement 2 | | | |
| PVDF in NEP after 16 h, measurement 1 | 579.1 | 577.8 | 573.3 |
| PVDF in NEP after 16 h, measurement 2 | 582.7 | 579.2 | 573.0 |
| PVDF in NEP after 5 days, measurement 2 | 583.0 | 580.2 | 575.3 |
| PVDF in NEP after 27 days | 584.6 | 578.6 | 572.1 |

It was found that, in the case of the solutions comprising NMP, the viscosity increased to a much greater degree in the course of time than was the case for the NEP solutions.

It was also found that the NEP solution has a constant viscosity even after approx. 16 h while the viscosity continued to rise even after 5 days in the case of the NMP solution.

1. A process for coating a carrier with a composition comprising a solvent, a dispersant, or both, and a polymeric binder,
wherein
the solvent, the dispersant, or both, comprises N-ethylpyrrolidone.

2. The process of claim 1, wherein the polymeric binder is at least one selected from the group consisting of a polyvinylidene fluoride homopolymer (PVDF), a polyvinylidene fluoride copolymer (PVDF copolymer), polytetrafluoroethylene (PTFE), polyvinyl chloride (PVC), polyvinyl fluoride (PVF), polychlorotrifluoroethylene (PCTFE), polychlorotrifluoroethylene-ethylene (ECTFE), polytetrafluoroethylene-ethylene (ETFE), polytetrafluoroethylene-hexafluoropropene (FEP), polymethyl methacrylate (PMMA), polyethylene oxide (PEO), polypropylene oxide (PPO), polypropylene (PP), polyethylene (PE), polyimide (PI), and styrene-butadiene rubber (SBR).

3. The process of claim 1, wherein the composition is a dispersion and further comprises an active material which enables an incorporation and release of electrically charged particles and which comprises at least one selected from the group consisting of graphite, an amorphous; carbon, a lithium storage metal, a lithium storage alloy, nanocrystalline silicon, amorphous silicon, a silicon-carbon composite, tin, aluminum, antimony, Li₄Ti₅O₁₂, a lithium metal oxide having a formula LiMₓO₂ wherein M is a metal atom, LiCoO₂, LiNiO₂, LiNi₁₋ₓCoₓO₂, LiNi_{0.85}Co_{0.1}Al_{0.05}O₂, Li₁₊ₓ(Ni_{y}Co_{1-2y}Mn_{y})₁₋ₓO₂ wherein 0≦x≦0.17 and 0≦y≦0.5, a doped or undoped LiMn₂O₄ spinel, a doped or undoped lithium-metal phosphate having a formula LiMPO₄ wherein M is a metal atom, LiFePO₄, LiMnPO₄, LiCoPO₄, LiVPO₄, and iron(III) fluoride (FeF₃).

4. The process of claim 1, wherein the composition further comprises at least one conductivity additive selected from the group consisting of a fine graphite having a d50 between 1 μm and 8 μm, a carbon black with primary particles having a size between 10 and 80 nm, and a carbon fiber.

5. The process of claim 1, wherein the carrier comprises a web of conductive material, the conductive material comprising at least one selected from the group consisting of aluminum; copper; a laminate comprising a foil of aluminum, copper or both; a porous carrier, a woven, a nonwoven or an expanded metal each comprising aluminum, copper, or both; and a polymeric foil, a perforated foil, a porous carrier, a woven or a nonwoven each coated with aluminum, copper, or both.

6. The process of claim 1, wherein the composition comprises 30 to 80% by weight of N-ethylpyrrolidone based on the weight of the composition.

7. The process of claim 1, wherein the composition has a viscosity in a range from 1000 to 7000 mPas at a shear rate of 112 s⁻¹, measured at 20° C.

8. The process of claim 1, wherein the composition comprises an active material which comprises at least one selected from the group consisting of graphite, an amorphous carbon, a lithium storage metal, a lithium storage alloy, nanocrystalline silicon, amorphous silicon, a silicon-carbon composite, tin, aluminum, antimony, and Li₄Ti₅O₁₂.

9. The process of claim 1, wherein the composition comprises an active material which comprises at least one selected from the group consisting of a lithium-metal oxide having a formula LiMₓO₂ wherein M is a metal atom, LiCoO₂, LiNiO₂, LiNi₁₋ₓCoₓO₂, LiNi_{0.05}Co_{0.1}Al_{0.05}O₂. Li₁₊ₓ(Ni_{y}Co_{1-2y}Mn_{y})₁₋ₓO₂, wherein 0≦x≦0.17 and 0≦y≦0.5, a doped or undoped LiMn₂O₄ spinel, a doped or undoped lithium-metal phosphate having a formula LiMPO₄ wherein M is a metal atom, LiFePO₄, LiMnPO₄, LiCoPO₄, LiVPO₄, and iron(III) fluoride (FeF₃).

10. A coated carrier produced by the process of claim 1.

11. An electrode produced by a process comprising the process of claim 1.

12. A composition comprising a solvent, a dispersant, or both, a polymeric binder, an active material which enables an incorporation and release of electrically charged particles, and optionally a conductivity additive, wherein the solvent, the dispersant, or both, comprises N-ethylpyrrolidone.

13. The composition of claim 12, comprising 30 to 80% by weight of N-ethylpyrrolidone, 0.5 to 8% by weight of the polymeric binder, 20 to 70% by weight of the active material, and 0 to 5% by weight of the conductivity additive, based in each case on the weight of the composition.

14. A method of producing an electrode for an electrical energy store, the method comprising N-ethylpyrrolidone.

15. A method of producing an electrode for an electrical energy store, the method comprising coating a carrier, wherein the coating is performed in the presence of a composition comprising N-ethylpyrrolidone.

16. The process of claim 1, wherein the composition comprises 30 to 80% by weight of N-ethylpyrrolidone, 0.5 to 8% by weight of the polymeric binder, and further comprises 20 to 70% by weight of an active material and 0 to 5% by weight of a conductivity additive, based in each case on the weight of the composition.

17. The process of claim 1, wherein the composition comprises 40 to 70% by weight of N-ethylpyrrolidone, 1 to 5% by weight of the polymeric binder, and further comprises 30 to 60% by weight of an active material and 0.2 to 3% by weight of a conductivity additive, based in each case on the weight of the composition.

18. The composition of claim 12, comprising a conductivity additive.

19. The composition of claim 12, comprising 40 to 70% by weight of N-ethylpyrrolidone, 1 to 5% by weight of the polymeric binder, 30 to 60% by weight of the active material and 0.2 to 3% by weight of the conductivity additive, based in each case on the weight of the composition.

20. The process of claim 1, wherein the composition comprises a polyvinylidene fluoride homopolymer (PVDF), a graphite, a carbon black, and M-ethylpyrrolidone.
